(19) United States
(12) Patent Application Publication
(10) Pub. No.: US 2007/0140400 A1
(43) Pub. Date: Jun. 21, 2007

(54) Cold fusion apparatus

(76) Inventor: John Andrew Hodgson, Safety Harbor, FL (US)

Correspondence Address: JOHN ANDREW HODGSON, P.O. BOX 202, SAFETY HARBOR, FL, 34695, US

(21) Appl. No.: 11/583,546

(22) Filed: Oct. 19, 2006

Related U.S. Application Data
(60) Provisional application No. 60/728,181, filed on Oct. 19, 2005.

(51) Int. Cl. H05H 1/22

(52) U.S. Cl. 376/100

(57) ABSTRACT

In accordance with the present invention, this invention creates the process of cold fusion with the creation of electromagnetic scalar waves and the deuterium loading of cathode in the invention. This process of combining the deuterium loading and current flow of the cathode with the electromagnetic scalar waves are used to allow temporary changes of the columbic barrier and the van der walls forces to lower levels that will allow fusion of the deuterium atoms in the helium atoms and the release of energy that is involved. Once all these conditions are met cold fusion will occur.

### RELATED APPLICATIONS

The present application is a continuation application of U.S. provisional patent application Ser. No. 60/728,181, filed Oct. 19, 2005, for COLD FUSION APPARATUS, by John Andrew Hodgson, included by reference herein and for which benefit of the priority date is hereby claimed.

### FIELD OF THE INVENTION

The present invention relates to the process of creating low level energy fusion process and specifically the electrolytic process of creating cold fusion

### BACKGROUND OF THE INVENTION

The use of petroleum, natural gas, coal and biomass fuel as sources of energy have caused concerns ranging from pollution and greenhouse gas production to rising prices and politically unstable sources. Other energy sources have their own problems. Wind and hydropower are limited or unreliable sources of energy; conversion of solar power to electricity is expensive; and nuclear power is burdened with safety, security and disposal concerns. A new means of providing energy with greater benefits and fewer problems is needed. Some investigators have recently reported that after many days of electrolysis of deuterium oxide (heavy water) using a palladium electrode, some of the conducted experiments developed excess heat which they proposed to indicate nuclear fusion. However, they did not find evidence for neutrons in amounts needed to correlate the heat evolved with the theory developed for high temperature fusion. The absence of neutrons and the difficulty in reproducing their results have caused the majority of nuclear physicists to reject the possibility of “cold” nuclear fusion reactions. On the other hand, other researchers have occasionally reported observing excess heat from deuterium-palladium and related experiments. Many papers have been published on the topic but, to date, the results have been sporadic. Problems with the attempts to achieve cold nuclear fusion revolve around reproducible initiation of the process and control and propagation of the initiated reaction. To date, conditions under which one can reliably conduct a cold nuclear fusion process have not been determined. It is the purpose of the present invention to provide a process that reliably achieves cold nuclear fusion and the production of energy therefrom. Specifically, the present invention defines the components that can provide for initiation of the reaction and for the propagation and control of the initiated process. The present invention further provides an apparatus that produces heat by utilizing deuterium fusion reaction under low temperature conditions.

5318675 June 1994 Patterson

5372688 December 1994 Patterson

Foreign Patent Documents

WO 90/10935 A1 September, 1990 WO

WO 90/13126 November, 1990 WO

WO 91/01036 A1 January, 1991 WO

WO 91/08573 A1 June, 1991 WO

WO 92/10838 June, 1992 WO

WO 93/17437 A1 September, 1993 WO

WO 94/29873 December, 1994 WO

WO 95/20816 A1 August, 1995 WO

WO 96/42085 A2 December, 1996 WO

### OTHER REFERENCES

Karabut, et. al., “Nuclear Product . . . Deuterium”, Physics Letters A170, (1992), p. 265. .Klein, “Attachments to Report of Cold Fusion Testing”, Cold Fusion, No. 9, pp. 16-19. .Labov, “Special Observations . . . Background”, The Astrophysical Journal, 371, Apr. 20, 1991, pp. 810-819.

Lehigh X-Ray Photoelectron Spectroscopy Report, Dec. 8, 1993.

Miles, et. al., “Search for Anomalous Effects . . . Palladium Cathodes”, Naval Air Warfare Center Weapons Divsion, Proceedings of 3.sup.rd Int. Conf. on Cold Fusion.

Miles et al, “Correlation of Excess . . . Palladium Cathodes”, J. Electronl. Chem., 1993, pp. 99-117.

Miles et al, “Heat and Helium . . . Experiments”, Conference Proceedings, vol. 33, 1991, pp. 363-372.

Miles et al, “Electrochemical . . . Palladium Deuterium System”, J. Electroanal Chem., 1990, pp. 241-254.

Mills, et. al., “Fractional Quantum . . . Hydrogen”, Fusion Technology, vol. 28, November 1995, pp. 1697-1719.

Mills, Unification of Spacetime, the Forces, Matter, Energy, HydroCatalysis Power Corporation, 1992, pp. 53-84.

Mills, “The Grand Unified Theory of Classical Quantum Mechanics”, pp. 1-9.

Mills, “Hydrocatalysis Power Technology”, Statement of Dr. Randall L. Mills, May, 1993.

Mills Technologies, “1 KW Heat Exchanger System”, Thermacore, Inc., Oct. 11, 1991, pp. 1-6.

Mills Technologies, “1 KW Heat Exchanger System”, Thermacore, Inc., Apr. 17, 1992, pp. 1-6.

Monroe, et. al., “A Schrodinger Cat Superposition State of an Atom”, Science, vol. 272, (May 24, 1996), pp. 1131-1101.

Morrison, “Review of Progress in Cold Fusion”, Transactions of Fusion Technology, vol. 26, December 1994, pp. 48-55.

Morrison, “Cold Fusion Update No. 12, ICCPG”, Jan. 17, 1997, available online at “www.skypoint.com”. . Cell”, NASA Technical Memorandum 107167, (February 1996). Niedra, “Replication of the Apparant Excess Heat Effect in Light Water . . . .Nieminen, “Hydrogen atoms band together”, Nature, vol. 356, Mar. 26, 1992, pp. 289-291.

Notoya, et. al., “Excess Heat Production in Electrolysis . . . Electrodes”, Proceedings of the Int. Conf. on Cold Fusion, Oct. 21-25, 1992, Tokyo, Japan. .Rees, “Cold Fusion . . . What Do We Think?”, Journal of Fusion Energy, (1991), vol. 10, No. 1, pp. 110-116.

Rousseau, “Case Studies in Patholigical Science”, vol. 80, American Scientist, (1992), pp. 54-63. .Service, “Cold Fusion:Still Going”, Newsweek Focus, Jul. 19, 1993. . Shaubach, et. al., “Anomalous Heat . . . Carbonate”, Thermacore, Inc., pp. 1-10.

Storms, et. al., “Electroyltic Tritium Production”, Fusion Technology, vol. 17, July 1990, pp. 680-695.

Taubes, “Bad Science”, Random House, 1993, pp. 303, 425-481. .Vaselli et al., “Screening Effect of Impurities in Metals: A possible Explanation of the Process of Cold Nuclear Fusion”, 11 Nuovo Cimento Della Societa Italiana di Fisica.

Williams, “Upper Bounds on Cold Fusion in Electrolytic Cells”, Nature, vol. 342, 23 Nov. 1989, pp. 375-384.

Yamaguchi et al, “Direct Evidence . . . Palladium”, NTT Basic Research Laboratories, (1992) pp. 1-10. .Zweig, “Quark Catalysis of Exothermal Nuclear Reactions”, Science, vol. 201, (1978), pp. 973-979.

Bush, et. al., Journal Electrochanal. Chem., vol. 304, pp. 271-278 (1991).

Shrivenvassan, et. al., 3.sup.rd Annual Conference on Cold Fusion (1992).

Notoya, Fusion Technology, vol. 24, p. 202 (1993). . Boston Globe, Wednesday, Apr. 19, 1989, “Successful nuclear fusion experiment by the Italians”.

Oka, Ohmori, et. al., Fusion Technology, vol. 24, p. 293 (1993). .et. al., “D.sub.2 O-fueled fusion power reactor using electromagnetically induced D-D.sub.n, D-D. sub.p, and Deuterium-tritium reactions—preliminary design of a reactor system”, Fusion. .Fusion Digest, “Cold Nuclear Fusion Bibliography”, 1993.

Rogers, “Isotopic hydrogen fusion in metals”, Fusion Technology, vol. 16, No. 2.

Fusion Digest, “Heat? Neutrons? Charged Particles?”, 1993.

Brodowsky, “Solubility and diffusion of hydrogen and deuterium in palladium and palladium alloys”, Technical Bulletin, Engelhard Indust., vol. 7, No. 1-2 (1966), pp. 41-50.

Prop. to the United Press, “Theory May Explain ‘Cold Fusion’ Puzzle”; 1991; Lexis Nexis Reprint. .The Associated Press, “Pennsylvania Company . . . Cold Fusion Mystery”; 1991, Lexis Nexis Reprint.

The New York Times, “2 Teams Put New Life in ‘Cold’ Fusion Theory”; 1991; Section A, p. 18, col. 1; Lexis Nexis Reprint.

The Washington Post, “Two New Theories on Cold Fusion . . . Scientists”; 1991; 1.sup.st. .Albagli et al., Journal of Fusion Energy, 9(2):133-148 (1990).

Alber et al., Z. Phys. A.—Atomic Nuclei, vol. 333, (1989), pp. 319-320.

Alessandrello et al., I1 Nuovo Cimento, 103A (11) 1617-1638 (1990). .Balke et al., Physical Review C, 42 91): 30-37 (1990).

Benetskii et al., Kratkie Soobshcheniya po fizike, No. 6, pp. 58-60, 1989 (translation of). .Besenbacher et al., Journal of Fusion Energy, 9 (3):315-317 (1990).

Bush et al., J. Electroanal. Chem., 304:271-278 (1991).

Chapline, UCRL—101583, July 1989, pp. 1-9. .Cooke, ORNL/FTR—3341, Jul. 31, 1989, pp. 2-15.

Cribier et al., Physics Letters B, vol. 228, No. 1, Sep. 7, 1989, pp. 163-166.

Faller et al., J. Radioanal. Nucl. Chem. Letters, vol. 137, No. 1, (Aug. 21, 1989), pp. 9-16.

Hajdas et al., Solid State Communications, vol. 72, No. 4, (1989) pp. 309-313.

Horanyi, J. Radioanal. Nucl. Chem., Letters, vol. 137, No. 1, (Aug. 21, 1989), pp. 23-28.

Kreysa et al., J. Electronanal. Chem. vol. 266, (1989) pp. 437-450.

Legett et al., Physical Review Letters, 63(2):191-194 (1989).

Lewis et al., Nature, vol. 340, Aug. 17, 1989, pp. 525-530. .Maly et al., Fusion Technology, vol. 24, November 1993, pp. 307-318.

McNally, Jr., Fusion Technology, 16(2):237-239 (1989).

Mills et al., Fusion Technology, 25:103 (1994).

Mills et al., Fusion Technology, vol. 20, (August 1991), pp. 65-81.

Miskelly et al., Science, vol. 246, No. 4931, Nov. 10, 1989, pp. 793-796.

Noninski, Fusion Technology, vol. 21, (March 1992), pp. 163-167.

Noninski et al., Fusion Technology, vol. 19, March 1991, pp. 364-368.

Ohashi et al., J. of Nucl. Sci. and Tech., vol. 26, No. 7, (July 1989), pp. 729-732.

Price et al., Physical Review Letters, vol. 63, No. 18, Oct. 30, 1989, pp. 1926-1929.

Salamon et al., Nature, vol. 344, Mar. 29, 1990, pp. 401-405. .Schrieder et al., Z. Phys. B-Condensed Matter, vol. 76, No. 2, pp. 141-142, (1989).

Shani et al., Solid State Communications, vol. 72, No. 1, (1989) pp. 53-57.

The New York Times, May 3, 1989, pp. A1, A22, article by M. Browne.

The Wall Street Journal, Apr. 26, 1989, p. B4, article by D. Stipp. .The Washington Post, May 2, 1989, pp. A1, A7, article by P. Hilts.

The Washington Post, Jul. 13, 1989, pp. A14.

The Washington Post, Mar. 29, 1990, p. A3.

The Washington Times, Mar. 24, 1989, p. A5, article by D. Braaten. .Ziegler et al., Physical Review Letters, vol. 62, No. 25, Jun. 19, 1989, pp. 2929-2932.

“A Past Experiment that was incomplete” http://www.kryon.com/k_chanelDNA04.html

Planetary Association of Clean Energy 1990 p. 77-103

http://www.hutchisoneffectonline.com/Research/pdf/TheHutchisonFile.pdf

Electric Spacecraft Journal of interactive research Issue 1993 93/0727/12

http://www.hutchisoneffectonline.com/Research/pdf/ESJAug201997.pdf

Electric Spacecraft Journal of interactive research Issue #4

Analysis of Metal altered by the Hutchison Effect

http://www.hutchisoneffectonline.com/research.htm

John Hutchison

You're on Your Own When You Violate the Laws of Physics (and Don't Take Notes) http://www.hutchisoneffectonline.com/article_hutchison-youronyourown.htm

#158 from R&D Innovator Volume 4, Number 5 May 1995

Electric Spacecraft Journal (Issue 9, 1993).

The article http://www.kryon.com/k_channeldna04.html “A past Experiment that was incomplete’ Describes the process of controlled cold fusion. The description of the process requires a standard cold fusion apparatus which Ponds and Fleishman created with an additional process of adding two ultrasonic generators to the electrolytic process created with the Ponds and Fleishman apparatus to create cold fusion. This description of the ‘a past experiment that was incomplete’ process describes that a transformer created an electromagnetic field and another piece of equipment creating oscillations in the megahertz range of frequencies to create electromagnetic scalar waves which was added to the chemistry process.

This article shows the basic requirements of the cold fusion process, however this included two external oscillation sources creating and transmitter of electromagnetic waves and electromagnetic scalar waves This invention is a improvement of that process by removing the two external oscillation sources and the transmission antenna describes as “One was a mild magnetic field created by a transformer and other piece of equipment creating electromagnetic waves in the process‘

This invention is an improvement of the process that while electromagnetic waves are mentioned. The angle of incidence of the electromagnetic fields are not described at right angles to each other in ‘a past experiemnt that was incomplete’ this the optimum angle of creation of electromagnetic scalar waves The invention uses the optimum angle of incidence of 90 degrees between both oscillator external coils

This invention is an improvement of the ‘A Past Experiment that was incomplete” that the transmission antenna is combined with the electromagnetic oscillator into a single functional unit to provide a means of transmission of electromagnetic energy and creation of electromagnetic energy in the process

U.S. Pat. No. 5,372,688 creates an unstable cold fusion reaction, this inventor tries to create an stable cold fusion reaction by the creation of palladium coated mircospheres or other metals which will form ‘metallic hydrides’ this reaction is unstable because it lacks a means of creation of stable electromagnetic scalar waves, and the U.S. Pat. No. 5,372,688 creates an cold fusion reaction only when the random electromagnetic scalar waves occur in conjunction the electrolytic cell for the production of heat energy

U.S. Pat. No. 6,024,935 shows the creation of ‘energy holes‘in the structure of the embodiments in the U.S. Pat. No. 6,024,935 thus creating cold fusion reactions, this reactions are unstable and random in origin because these embodiments have no constant electromagnetic scalar wave reactions involved in the combination of the two reactions required in the cold fusion process. The 1st process is the ‘deuterium loading of cathode structure noted in FIG. 6’ to create reductions of the atomic radii of the deuterium atoms inside the crystalline interstitial structure of the cathode the current flow created in the process of electrolytic process 2nd process is the random injection of electromagnetic scalar waves into the atomic radii of the deuterium atoms and the atomic radii of the interstitial crystalline structure of the cathode element the 2nd process is not noted in the U.S. Pat. No. 6,024,935 and lacks a means of constant injection of a stable electromagnetic scalar waves in the cathode structure noted in FIG. 6 of U.S. Pat. No. 6,024,935; or any embodiments in the U.S. Pat. No. 6,024,935

WO 96/42085 PCT/US96/07949 shows the creation of ‘energy holes’ in the structure of the embodiments in the patent WO96/42085 thus creating cold fusion reactions, this reactions are unstable and random in origin because these embodiments have no constant electromagnetic scalar wave reactions involved in the combination of the two reactions required in the cold fusion process. The 1st process is the ‘deuterium loading of cathode structure noted to create reductions of the atomic radii of the deuterium atoms inside the crystalline interstitial structure of the cathode the current flow created in the process of electrolytic process 2nd process is the random injection of electromagnetic scalar waves into the atomic radii of the deuterium atoms and the atomic radii of the interstitial crystalline structure of the cathode element the 2nd process is not noted in the patent WO 96/42085 and lacks a means of constant injection of a stable electromagnetic scalar waves in the cathode structure noted in patent WO 96/42085 any embodiments in the patent 6 WO 96/42085

Patent WO 95/20816 claims ‘a heating step in which said core is charged with hydrogen isotopes is heated to reach a temperature higher than a threshold temperature corresponding to Debye's constant temperature of the material composing said core. This invention does not require a heating step in the cathode core to induce cold fusion reactions Patent WO 95/20816 A1 claims ‘a magnetic field having an intensity greater than 0.1 tesla's is applied to said core. The patent fails to create a stable electromagnetic scalar waves for creating of the cold fusion process. The electromagnetic scalar waves are created randomly with the interactions of other random magnetic fields interacting with the electromagnetic energy that is applied to the core.

Patent WO/92/10838 creates an unstable cold fusion reaction by the creation of a lower level and small dimensions by providing an “energy hole resonant” this is an attempt to change the columbic charge by the creation of the lower energy level atomic structure. within a resonator cavity. This ‘energy hole resonant’ is to be created by a photon source and a power oscillator. This arrangement does not create an stable electromagnetic scalar wave to induce change in the coulomb charge of an atomic structure.

Patent WO91/008573 creates an random cold fusion reaction by the single usage of the electromagnetic waves, in conjunction with randomized electromagnetic energy present in space around and within the apparatus some electromagnetic scalar waves are created by the 90 degree turn of the ‘wave guide apparatus’ with the single electromagnetic field this invention also attempts to change the barriers that are inherent in the atomic structures will only create unstable electromagnetic scalar wave that are needed to create cold fusion process this is an attempt to change the coulomb barriers with a single electromagnetic field source and only creates unstable electromagnetic scalar waves when the 90 degree changes in the wave guide structure, in the apparatus the 90 degree changes are used to enhance the loading of deuterium atom in the interstitial crystalline structures used in the lining of the ‘wave guide’ structure; and is not created or designed to create electromagnetic scalar waves specifically

Patent WO/91/01036 creates unstable and randomized electromagnetic scalar waves with no controlled and stable electromagnetic waves which are needed in the cold fusion process, this invention only has a single electromagnetic source injection in the cathode interstitial crystalline structure the source of unstable and randomized electromagnetic scalar waves is created when the electromagnetic waves in and around the apparatus intersect with the single source of electromagnetic waves generated in the apparatus

Patent WO90/13126 creates an unstable cold fusion reaction by the creation of a lower level and small dimensions by providing an “energy hole resonant” this is an attempt to change the columbic charge by the creation of the lower energy level atomic structure. within a resonator cavity. This ‘energy hole resonant’ is to be created by a photon source and a power oscillator. This arrangement does not create an stable electromagnetic scalar wave to induce change in the coulomb charge of an atomic structure.

Patent WO90/10935 This invention creates unstable cold fusion, there is no Electromagnetic waves created to create electromagnetic scalar waves in the invention The cold fusion reactions are random because of the random insertion of naturally occurring electromagnetic scalar waves in space and around the invention

It is therefore an object of the invention to create a source of energy to create heat It is another object of the invention to provide an alternative source of energy for generation of electricity

It is another object of the invention to provide environmental preservation by reducing the current oil base generation of energy and to begin a conversation to a hydrogen base production of energy

### SUMMARY OF THE INVENTION

In accordance with the present invention, This invention creates the process of cold fusion with the following process to take place there is power supplied to the power supply and power is supplied to the 1st oscillator with also the following power supplied to the cathode and anode located in the vessel that contains the electrolytic heavy water solution. There is current flow that is occurring from the power supply to the anode with the electrolyte solution to the platinum cathode back to the power supply. During this current flow heavy water or deuterium is deposited into the cathode crystalline structure element palladium; this is called loading of the deuterium into the spaces provided by the palladium. Also at the moment in time electromagnetic wave energy is being inducted from the 1st oscillator with the coil that is inside the vessel. The optimum exchange of energy will occur when the 1st oscillator is tuned to a resonant frequency that is adjusted to the cathode core. megaherts frequency is believed to be the best frequency range for the 1st and 2nd oscillator frequency range. Monitoring of the amount of current flow and the maximum induction of oscillator energy is monitored via a tap that is connected to the cathode core wiring by adjusting the oscillator frequency to a maximum energy level monitored with a oscilloscope. After the saturation of the deuterium is completed inside the palladium core, the 2nd oscillator is turned and adjusted to a frequency that is used to minimize the amount of alternating current on the cathode core, this is an nullification of the oscillator energy into a creating of electromagnetic scalar wave to be generated. The stabilization of the electromagnetic scalar wave are created by two means the 1st one is the adjustment of the 2nd oscillator frequency to nullify the 1st oscillator frequency the 2nd process of stabilization of the electromagnetic scalar waves are created by the creation of an 90 angle of incidence between the 1st and 2nd oscillator coils this is called ‘designer magnetic fields’ the physical arrangement of the inductor coils involved This injection of the electromagnetic scalar wave are critical, and used to change the structure of the deuterium atoms and the palladium cathode core. This process is created because the structure of an electromagnetic field is a 4d projection of magnetic energy that is based from a 12d source within an atom structure that is beyond the electron cloud and that 12d is the barrier that exists from the proton to the electron. And when two 4d electromagnetic waves are re-intersected in a very specific pattern and frequencies they will change the 12d structure of the deuterium and palladium atoms in the cathode core, this change is used to allow temporary changes of the columbic barrier and the van der walls forces to lower levels that will allow fusion of the deuterium atoms in the helium atoms and the release of energy that is involved. It is important to know that the processes involved are not linear in nature by occurring in a linear fashion but in a simultaneous manner occurring when all the critical conditions are met. Once all these conditions are met Cold Fusion Process will occur and the generation of heat is created during the process

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a FIG. 1 number 1 is an insulated conductive wire that provides direct current power to the anode cathode FIG. 1 number 2 is the insulated conductive wire that provides current power to the anode FIG. 1 number 3 is the anode coil FIG. 1 number 4 is the cathode core;

FIG. 2 is a perspective view of an inner inductive coil FIG. 2 number 5 is the insulated electricall conductive wire providing connectivity from the outer inductive coil to the 1st oscillator tank circuit FIG. 2 number 6 is the insulated electrical conductive wire providing connectivity from the outer inductive coil to the 1st oscillator tank circuit FIG. 2 number 7 is the regular spacing of the electrical induction coil that make up the inductance portion of the oscillator tank circuit FIG. 2 number 8 is the 45 degree angle relative to the wiring of FIG. 2 number 5 and FIG. 2 number 6 FIG. 2 number 8 is also 90 degree relative to the outer inductor coil FIG. 3 number 12;

FIG. 3 is a perspective view of an outer inductor coil FIG. 3 number 9 is an insulated conductive wire to provide connectivity from the outer inductive coil to the 2nd oscillator tank circuit FIG. 3 number 10 is an insulated electrical conductive wire to provide connectivity from the outer inductive coil to the 2nd oscillator tanks circuit FIG. 3 number 11 is the regular spacing of the outer inductor coil to create regular inductance for the 2nd oscillaotr tank circuit FIG. 3 number 12 is the 45 degree angle that the inductive outer coil is relative to the angle of the FIG. 3 number 9 insulated electricat conductive wire and FIG. 3 number 10 insulated electrical conductive wire FIG. 3 number 12 is also 90 degree realtive to the inner inductor coil FIG. 2 number 8;

FIG. 4 is a perspective view of a vessel that contains the inner and outer inductive coils with anode and cathode components with electrolyte heavy water and electrical insulated and non insulated components FIG. 4 number 13 is,an insulated conductive wire that connects to the 1st oscillator tanks circuit FIG. 4 number 14 is an insulated conductive wire that connects to the 2nd oscillator tank circuit FIG. 4 number 15 is an insulated conductive wire that connects the cothode to a power source FIG. 4 number 16 is an insulated conductive wire that connects the anode to a power source FIG. 4 number 17 is an insulated conductive wire that connects the outer inductive coil to the 1st oscillator tank circuit FIG. 4 number 18 is the insulated conductive wire that connectrs the outer inductive coil to the 2nd oscillator tank circuit FIG. 4 number 19 is a vessel that will support the electrolyte colution and the lid for the vessel FIG. 4 number 20 is the electrolyte heavy water solution FIG. 4 number 21 si the angle of incidence of the outer inductive coil that is 45 degrees angle relative to the FIG. 4 number 18 insulated conductive wire FIG. 4 number 22 is the angle of incidence of the inner inductive coil that is 45 degrees relative to the FIG. 4 number 13 insulated conductive wire and is 90 degrees relative to the outer inductive coil FIG. 4 number 23 is the anode FIG. 4 number 24 is the cathode FIG. 4 number 25 shows the 90 degree angle of incidence of the inner and outer inductive coils FIG. 4 number 26 is the bottom of the vessel that support the lid to the vessel and the electrolyte and heavy water solution FIG. 4 number 92 is an representation of the electrolyte level that cover the inner and outer inductive coil the cathode and anode;

FIG. 5 is a perspective view of a vessel lid holes wires FIG. 5 number 34 is the vessel that will prove support for the electrolyte and heavy water solution and lid FIG. 5 number 33 is the lid that will isolate the atmosphere from the electrolyte solution FIG. 5 number 32 is the insulated electrical conductive wire that connects the FIG. 4 number 18 insulated electrical conductive wire to the 2nd oscillator tank circuit circuit FIG. 5 number 31 is the insulated electrical conductive wire to the 1st oscillator tank circuit FIG. 5 number 30 is the insulated electrical conductive that provides power to the FIG. 4 number 16 insulated electrical conductive wire FIG. 5 number 29 is the insulated electrical conductive wire that provides power to the FIG. 4 number 15 insulated electrical conductive wire FIG. 5 number 28 is the insulated electrical conductive wire that connects the FIG. 4 number 14 insulated electrical conductive wire FIG. 5 number 27 si the insulated electrical conductive wire that connects the FIG. 4 number 13 wire to the 1st oscillaotr tank circuit FIG. 5 number 35 is a hile in the FIG. 5 number 33 lid this hole is snug enough to prove support to the inductive outer coil inside the vessel and snug enough to seal any outside atmosphere from creating contamination to the electrolyte heavy water solution in the vessel FIG. 5 number 36 is a hole in the FIG. 5 number 33 lid this hole is snug enough to provide support to the inductive inner coil inside the vessel and snug enough to seal any outside atmosphere from creating contamination to the electrolyte heavy water solution in the vessel FIG. 5 number 37 is a hole in the FIG. 5 number 33 lid this hole is snug enough to provide support to the cathode inside the vessel and snug enough to seal any outside atmosphere from creating contamination to the electrolyte heavy water solution in the vessel FIG. 5 number 38 is a hole in the FIG. 5 number 33 lid this hole is snug enough to seal any outside atmosphere from creating contamination to the electrolyte heavy water solution in the vessel FIG. 5 number 39 is a hole in the FIG. 5 number 33 lid this hole provides support to the inner inductive coil insid ethe vessel this hole is also snug enough to seal outside atmossphere from creating comtamination to the electrolyte heavy water solution FIG. 5 number 40 is a hole in the FIG. 5 number 33 lid this hole is snug enough to provide support to the outer inductive coil inside the vessel this hole is also snug enough to seal outside atmospohere from creating contamination to the electrolyer heavy water solution;

FIG. 6 is a perspective view of an additional embodiment of th ecinfigureation of th einductive inner and outer loops and the placement of the anode realtive to the cathode FIG. 6 number 41 is the insuilated electrical wire that connects the 1st oscillator tank circuit to the inner electrical inductive coil FIG. 6 number 42 is the insulated electrical wire that connects the 2ns oscillator tanks circuit to the outer electrical inductive coil FIG. 6 number 43 is a insulated electrical wire tha tconnects the power source to the cathode FIG. 6 number 44 is the insulated electrical condictive wire that is connected to the cathode note this arrangement places the cathode wire outside of both inner and outer inductive loop coils FIG. 6 number 45 is the electrolyte heavy water solution FIG. 6 number 44 is the anode FIG. 6 number 47 is the outer coil degree angle of incidence relative to the FIG. 6 number 46 wire FIG. 6 number 48 is th einner coil with 45 degree angle of incidence to the FIG. 6 number 41 insulated electrical wire and 90 degree relative angle of incidence to the FIG. 6 number 41 insulated electrical wire and 90 degrees realive angle of incidence to the outer electromagnetic inductive coil FIG. 6 number 50 is the cathode FIG. 6 number 51 is te 90 degree angle of incidence that is relative to the inner inductive coil loop FIG. 6 number 52 si the bottom of the vessel that suports the electrolyte heavy water solution and lid FIG. 6 number 93 is the electrolyte heavy water solution line depectin the electrolye heavy water coverin gth einner and outer inducitve coild and the anode and cathode components;

FIG. 7 is a perspective view of an alternative embodiment of the inner and outer coil configureation the FIG. 7 number 55 is the inductive coil FIG. 7 number 54 is the regulaer spacing of th einductive coil FIG. 7 number 53 is the addition of an magnetic core to increase the electromagnetic waves being generated FIG. 7 number 94 is the insulated electrical conductive wiring that connects the inductive coil to the oscillator tank circuit FIG. 7 number 95 is an insulated electrical conductive wiring that connects the inductive coil to the oscillator tank circuit;

FIG. 8 is a perspective view of an alternative embodiment of vessel that supports the heavy water electrolyte with oscillator cathode anode FIG. 8 number 64 is the solid state oscillator which is also 45 degree angle of incident to the FIG. 8 number 69 and FIG. 8 number 61 is the wire that support to the solid state oscillator and provides connectivity to the oscillator tank circuit FIG. 8 number 59 is an wire that provides support to the solid state oscillator and provides connectivity to the oscillator tank circuit FIG. 8 number 60 is an insulated conductive wire that provide support to the cathode FIG. 8 number 59 is an insulated conductive wire that provide supoer to the cathode FIG. 8 number 59 is an insulated conductive wire that provide support to the second oscillator FIG. 8 number 58 is an insulated conductive wire that provides support to the second oscillaotr circuit FIG. 8 number 69 is the 2nd solid state oscillator and is referenced 90 degrees to the 1st oscillator and also at an angle of incidence of 45 degrees to the FIG. 8 number 59 wire and FIG. 8 number 58 wire and is also 90 degree angle of reference to the 1sat oscillator FIG. 8 number 63 is the heavy water electrolyte solution FIG. 8 number 68 is the bottom of the vessel FIG. 8 number 56 is the cathode FIG. 8 number 70 is the anode FIG. 8 number 56 is an insulated electrical conductive wire to connect the anode to the power source;

FIG. 9 is a perspective view of an alternative embodiment an anode inner oscillator outer oscillator electrolyte anode FIG. 9 number 71 is the anode FIG. 9 number 72 is an insulated electrical wire that connects the FIG. 9 number 71 cathode to a power source FIG. 9 number 73 is the outer oscillator FIG. 9 number 74 is the inner oscillator FIG. 9 number 75 is the cathode core FIG. 9 number 77 is an electical insulator FIG. 9 number 78 is an electical insulator FIG. 9 number 80 is an electrical insulator FIG. 9 number 79 is an representation of the helectrolyte heavy water solutino FIG. 9 number 81 is the outer oscillator core FIG. 9 number 82 is the inner oscillator core FIG. 9 number 97 is an insulated electrical wire providing power and connects to te 1st oscillator electmanetic tank circuit FIG. 9 number 83 is an insulated electrical wire providing power and connects to the 2nd oscillating electromangetic tank circuit FIG. 9 number 84 is the bottom of the essel that provides support for the FIG. 5 number 33 lid and contains the electrolyte solution FIG. 9 number 180 is the cathode core;

FIG. 10 is a perspective view of an alternative embodiment of inner oscilaltor core outer oscillator core FIG. 10 number 85 is the solid state oscillating inner core FIG. 10 number 86 shows the orientation of the oscillatoring electromagnetic wave produced by the solid state oscillator FIG. 10 number 87 is the instulated electrical conducting wire that connects the inner solid state core to an electrical oscillating tank circuit FIG. 10 number 91 is the insulated electrical conducting wire that connects the inner solid state core to an electrical oscillation tank circuit FIG. 10 number 88 is the electrical insulator that sepatates the inner oscillating core to the outer oscillating core FIG. 10 number 99 is the solid state oscillating outer core FIG. 10 number 100 is the orientation of the oscillating electromagnetic wave produced by the solid state oscillator core FIG. 10 number 89 is an insulated electrical conducting wire that connects the outer solid state core to an electrical oscillation tank circuit;

FIG. 11 is a perspective view of an overall construction of the cold fusion appatatus FIG. 11 number 101 is the electrical conductive wires that connect the power plug FIG. 11 number102 to a power source FIG. 11 number 103 is the positive alternative current voltage insulated electrically conductive wire FIG. 11 numbaer 104 is the netural alternative current voltage insulated electrical conductive wire FIG. 11 number 105 is the power supply assemble FIG. 11 number 106 is the power distribution module supplying power to the FIG. 11 number 107 1st oscillator FIG. 11 number 108 is the 2nd oscillator FIG. 11 number 109 is the insulated electrical conductive wire connecting the 1st oscillatore adjustable tank circuit to the outer inductor coil FIG. 11 number 110 is the insulated electrical conductive wire connected the 2nd oscillator adjustable tank circuit to te inner inductor coil FIG. 11 number 111 is the insulated electrical conductive wire connecting the cathode to the power supply assemble FIG. 11 number 105 FIG. 11 nuber 112 is the insulated electrical conductive wire connectng the anode to the power supply assemble FIG. 11 numbet 105 FIG. 11 number 113 is the insulated electical conductive wire connecting the FIG. 11 number 2nd oscillator adjustable tank circuit to the inner inducore coil FIG. 11 number 114 is an insulated electrical conductive wire connecting the 1st oscillator adjustable tank circuit to the outer inductor coil FIG. 11 number 115 is an hole in the FIG. 121 lid that is large enough to fit an wire though the hole and sung enough to provide isolation of the outside atmosphere air to the heavy water electrolyte solution FIG. 11 number 116 is an hole in the FIG. 121 lid that is large enough to fige an wire though the hole and sung enough to prove isolation of the outside atmosphere to the heavy water electrolyte solution FIG. 11 number 117 is an hole in the FIG. 121 lid that is large enough to fit an wire though the hole and sung enough to provide isolation of the outside atmosphere to the heavy water electrolyte solution FIG. 11 number 118 is an hole in the FIG. 121 lid that is large enough to fit an wire though the hole and sung enough to provide isolation of the outside atmospohere to the heavy water electrolyte solution FIG. 11 number 119 is an hold in the FIG. 121 lid that is large enough to fit an wire though the hole and sung enough to provide isiolation of the outside atmosphere to the heavy water electrolyte solution FIG. 11 number 121 is an hold in the FIG. 121 lid that is large enough to fit an wire though the hole and sung enough to provide isolation of the outside atmosphere to the heavy water electrolyte solution FIG. 11 number 123 is the vessel that supports the lid and electrical wireing to support he components inside the vessel FIG. 11 number 124 is the adjustment that is part of the 2nd oscillator acapacitors of the colpitts oscilaltor tank circuit FIG. 11 number 125 is the 1st adjustable oscillator tank circuit FIG. 11 number 153 si the switch that connects the power supply common ground to the 2nd oscilaltor tank circuit;

FIG. 12 is a perspective view of a fo the connection of the oscillator tank circuits to the inner and outer inductive coils FIG. 12 number 126 is an representation of the inner inductive coil FIG. 12 number 127 is an representation of the outer inductor coil FIG. 12 number 128 is the switch that gives common ground to the 2nd adjustable oscillator tank circuit FIG. 21 number 129 is the 2nd adjustable oscillator tanks circuit FIG. 12 number 130 is the 1st adjustable oscillator tank circuit FIG. 12 number 149 is the representation of the power supply assembly FIG. 12 number 150 is the common ground that connects to the FIG. 12 number 129 adjustable oscillator tank circuit FIG. 12 number 151 is the common ground that connects to the FIG. 12 number 130 adjustable oscillator tankd circuit;

FIG. 13 is a perspective view of an of the complete setup to adjust the 1st and 2nd oscillator tank circuit FIG. 13 number 131 isthe insulated electrical plug that connects the supplied power ot the power supply assembly FIG. 13 number 133 FIG. 13 number 132 is the insulated electrical cord that supplies connectivity from the insulated electrical plug to the power supply assembly FIG. 13 number 133 FIG. 13 number 134 is the insulated electrical wire that connects the FIG. 13 number 133 power supply assembly to the anode in FIG. 13 number 136 vessel FIG. 13 number 135 is the tap component on the FIG. 13 number 177 electrical wire that connects the FIG. 13 number 133 power assembly to the cathode in FIG. 13 number 136 vessel FIG. 132 number 137 is the oscillator scope that voltage meanurement are taken off the tap circuit FIG. 13 number 135 tap;

FIG. 14 is a perspective view of a 1st oscillator colpitts circuit FIG. 14 number 138 is the common ground electrical connection that is supplied from the power supply FIG. 14 number 139 si the electrical connection that is supplied from the power supply ac circuit that provides energy to heat the filament in the FIG. 14 number 147 tube FIG. 14 number 140 is the electrical connection that is supplied from the power supply ac circuit that provide energy to heat the filament in the FIG. 14 number 147 tube FIG. 141 is the electrical connection that supplies a grid voltage from the power supply to the FIG. 14 number 147 tube FIG. 142 is the electrical connection that supplies a collector voltage to the tank circuit comprising the FIG. 14 number 143 inductor and the FIG. 14 number 144 c1 adjustable capacitor FIG. 14 number 143 si the inductor coil that is in the vessel containg the inductor coil FIG. 14 number 144 is an ganged adjustable tank circuit FIG. 14 number 145 is the device that connects the FIG. 14 number 144 capacitor tank circuit and FIG. 14 number 148 adjustable capacitor FIG. 14 number 147 si the triode tube FIG. 14 number 147;

FIG. 15 is a perspective view of a power supply assembly FIG. 15 number 154 is teh insulated electrical plug that connects outside supplied power to the FIG. 15 number 157 power supply assembly FIG. 15 number 155 is the electrical connection that connects the FIG. 15 number 154 electrical plus to the FIG. 15 number 156 power supply collector voltage to the 1st adjustable oscillator and 2nd adjustable oscillator FIG. 15 number 159 is the grid biasing voltage for the 2nd oscillator tube FIG. 15 number 161 is the electrical connection connecting the ac heater voltage to the 1st oscillator tube FIG. 15 number 162 is the electrical connection connecting the ac heater voltage to the 1st oscillator tube FIG. 15 number 178 is the electrical connection connecting the ac heater voltage to the 2nd oscillator tube FIG. 15 number 163 is the electrical connection connecting the common ground from the power supply FIG. 15 number 156 to the 1st oscillator tank circuit FIG. 15 number 165 is the electrical connection connecting the common ground from the power supply from the power supply FIG. 15 number 156 to the 2nd oscillator tank circuit FIG. 15 number 164 is the switch that connects the electrical connection of the common ground to the 2nd oscillator tank circuit; and

FIG. 16 is a perspective view of a 2nd oscillator colpitts circuit FIG. 16 number 166 is the common ground electrical connection that is supplied from the power supply FIG. 16 number 167 si the electrical connection that is siupplied form the power supply ac circuit that provides energy to heat the filament in the FIG. 16 number 176 tube FIG. 16 number 168 is the electrical connection that is supplied from the power supply ac circuit that provide energy to heat the filament in the FIG. 16 number 176 tube FIG. 16 number 169 is the electrical connection that supplies a grid voltage from the power supply to the FIG. 16 number 176 tube FIG. 16 number 170 is the electrical connection that supplies a collector voltage to the tank circuit comprising the FIG. 16 number 171 inductor and the FIG. 16 number 172 c1 adjustable capacitor FIG. 16 number 171 is the inductor coil that is in the vessel that containaing the inductor coil FIG. 16 number 172 is an ganged adjustable tank circuit FIG. 16 number 173 is the device that connects the FIG. 16 number 174 adjustable capacitor and FIG. 16 number 172 adjustable capacitor FIG. 16 number 176 is the triode tube FIG. 16 number 175 is the resistor that supplies voltage bias to the emitter grid of the FIG. 15 number 176 tube.

For purposes of clarity and brevity, like elements and components will bear the same designations and numbering throughout the FIGURES.

### DESCRIPTION OF THE PREFERRED EMBODIMENT

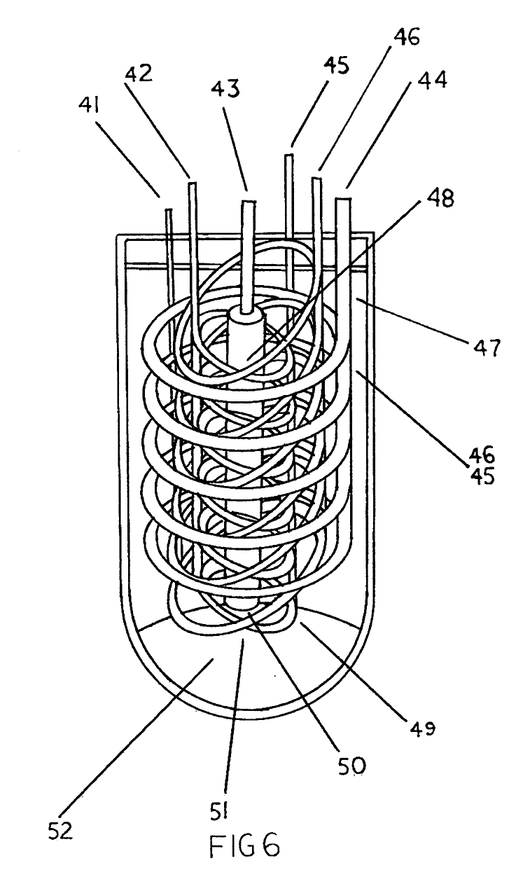

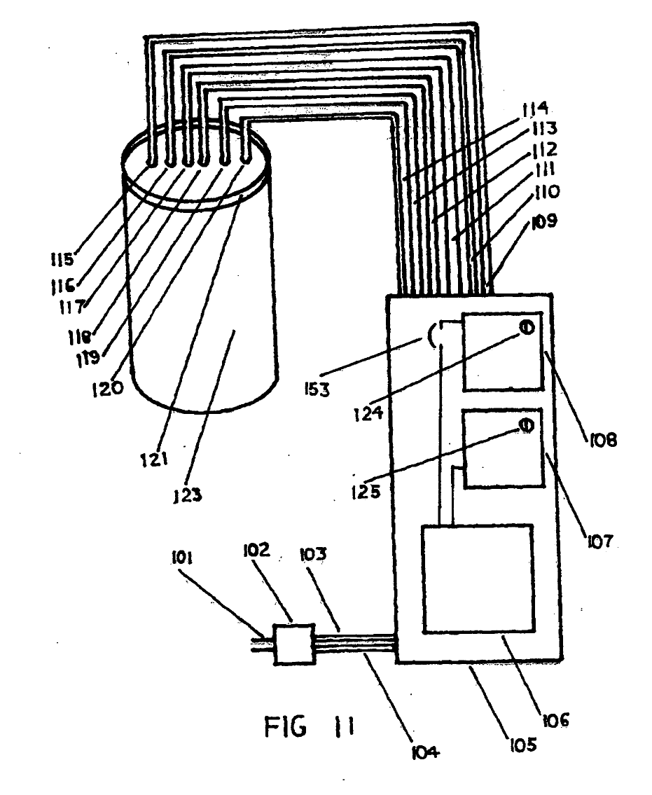

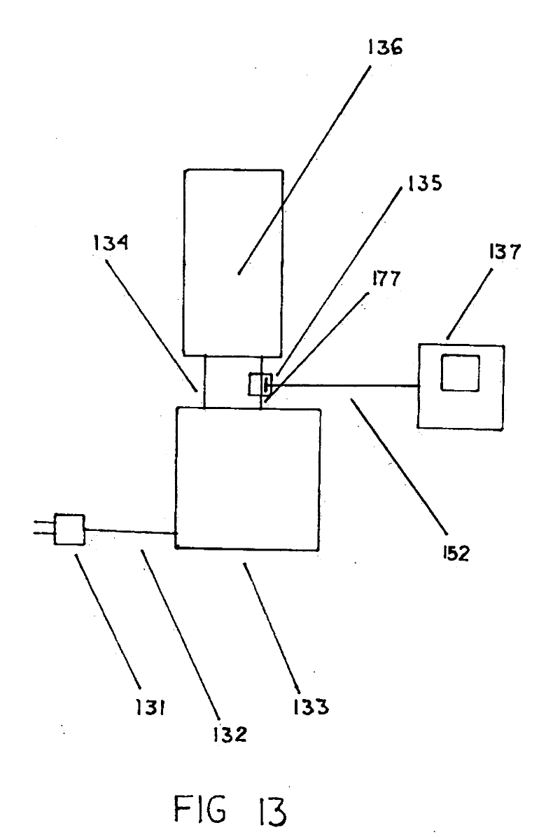

Operational Step of the invention Step 1 power is supplied to the power plug FIG. 11 number 102 and power is supplied to power supply 10 assembly FIG. 11 number 105 Step 2 FIG. 11 number 106 power supply 10 supplies power to the anode 16 FIG. 6 number 44 the cathode 14 FIG. 6 number 43 to the 1st adjustable oscillator tank circuit FIG. 11 number 107 the 2nd adjustable oscillator tank circuit FIG. 11 number 108 Step 3 Electrical current is created with power applied to the anode 16 and cathode 14 and electrolyte 22 heavy water solution Step 4 the 1st adjustable oscillator tank circuit is generating stable oscillations with the external outer inductor coil FIG. 6 number 47 Step 5 The oscilloscope FIG. 13 number 137 is properly setup and currently has a electrical connection tap FIG. 13 number 135 and a connecting cable FIG. 13 number 152 to connect the electrical connection tap to the oscilloscope to monitor the voltage running across the wire FIG. 11 number 111 to monitor the electrical voltage running across the electrolytic current Step 6 monitor the amount of voltage dc and ac running across the tap FIG. 13 number 135 that is connected to the cathode 14 FIG. 6 number 48 portion of the circuit Step 7 Adjust the 1st adjustable ganged capacitor tank circuit adjustor FIG. 11 number 125 and adjust the 1st oscillator tank circuit comprising the FIG. 11 number 107 tank circuit plus the outer part of the tank circuit FIG. 6 number 47 inductor tank circuit to a peak ac and dc voltage reading on the oscilloscope FIG. 13 number 137 Step 8 Turn on the switch FIG. 11 number 153 to an on position creating a complete electrical circuit to the 2nd adjustable oscillator tank circuit comprising the adjustable oscillator tank circuit FIG. 11 number 108 and the inner inductor tank coil FIG. 6 number 49 to a minimum ac and dc voltage reading on the oscilloscope FIG. 13 number 137 Step 9 Cold Fusion processes will begin to create heat energy from the cold fusion process to be tapped via the electrolyte 22 solution it is believed that the optimium range of electromagnetic frequency range is the megahertz range of frequencies for both oscillators

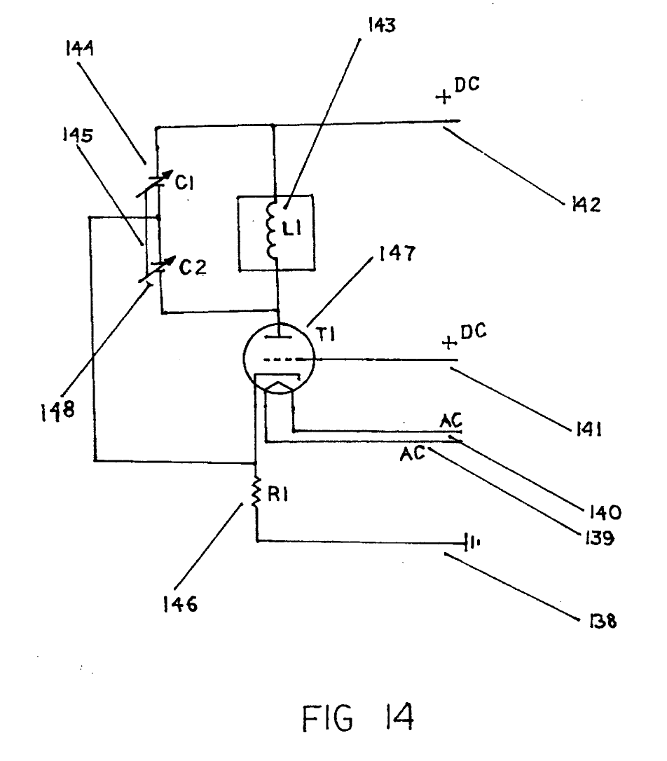

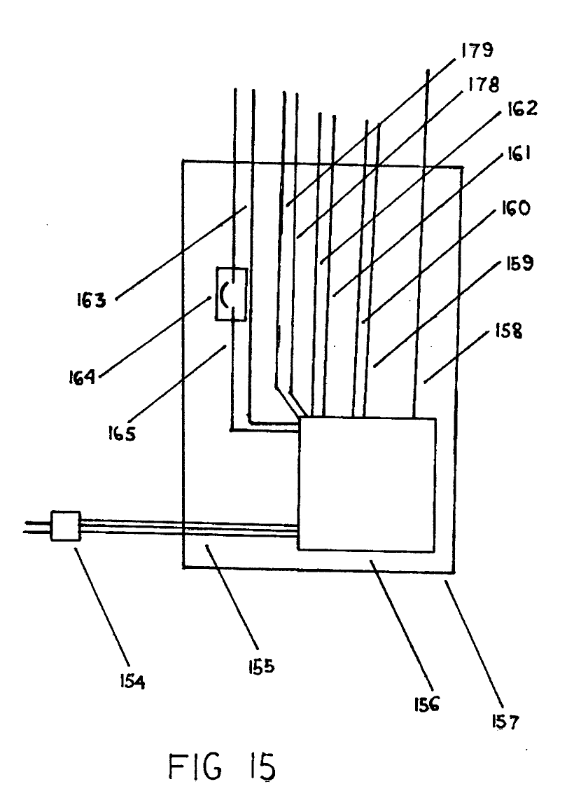

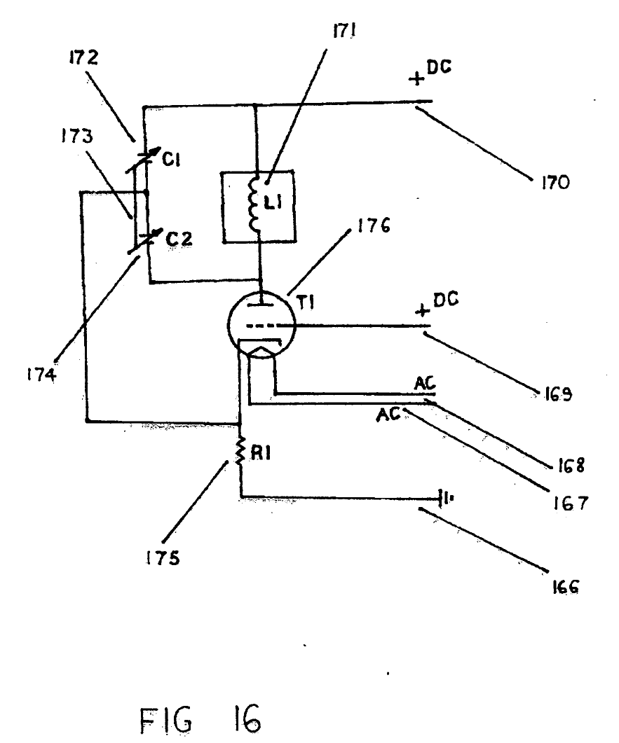

Detailed Operation of the Cold Fusion Device 1. Electrical conducting metal FIG. 11 number 101 is connected to a power source ad power 115 volts alternating current is applied to the electrical plug FIG. 11 number 102 and power is then fed to the positive portion of the FIG. 11 number 103 wire 2. And the neutral portion of the ac power flow FIG. 11 number 104 is then applied to the power supply 10 assembly FIG. 11 number 105 and power is flowed in the power supply 10 FIG. 11 number 106 and power is created for the anode 16 FIG. 6 number 46 and cathode 14 FIG. 6 number 50 and the electrolyte 22 heavy water solution containing deuterium and the electrical circuit is complete 3. Power is supplied to the FIG. 15 number 157 power supply 10 assembly 4. collector voltage FIG. 14 number 147 t1 tube and FIG. 16 number 176 t1 tube is supplied from FIG. 15 number 158 wire from the power supply 10 FIG. 15 number 156 5. Positive ac voltage FIG. 15 number 159 and neutral side of the ac voltage circuit FIG. 15 number 160 provides heater voltage for the t1 tube FIG. 14 number 147 and heater voltage for the t1 tube FIG. 16 number 176. 6. The common chassis ground supplies electrical connection to the 1st oscillator circuit 7. Common chassis ground supplies electrical connection the 2nd oscillator 20 circuit FIG. 15 number 165 7. Common chassis ground to the 2nd oscillator 20 circuit FIG. 15 number 164 8. grid voltage is supplied from wire FIG. 15 number 161 to t1 tube FIG. 14 number 147 and grid voltage is supplied from wire FIG. 15 number 162 to t1 tube FIG. 16 number 176. 9. current flow in cathode 14 FIG. 6 number 50 creates a transition from static wave state of the electrons on the palladium surface and within the crystalline interstitial structure of the palladium element thus increasing the wave state of the electrons around the palladium atoms this wave state is increased thus creating electrical current flow 10 1st oscillator inductor tank circuit inductor coil FIG. 6 number 49 creates the oscillating electromagnetic wave that is tuned to resonate with the FIG. 6 number 50 cathode 14 11. 2nd oscillator 20 inductor tank circuit inductor coil FIG. 6 number 48 is tuned to create mutual interference of electromagnetic waves into electromagnetic scalar waves 12. the electrolyte 22 solution and the current path from the anode 16 to the cathode 14 injects deterium atoms into the palladium crystalline interstitial structure of the palladium element 13. the process of the electrolytic current with the two electromagnetic fields are created at 90 right angles this specific angle creates an addition element of the electromagnetic scalar wave induction into the FIG. 6 number 50 cathode 14 this inter-reaction of the three elements the electromagnetic scalar waves plus the electron electrolyte 22 current flow plus the loading of the deterium atoms in the palladium it is believed that the optimium range of electromagnetic frequency range is the megahertz range of frequencies for both oscillators cathode 14

Inventors Theory of Operation

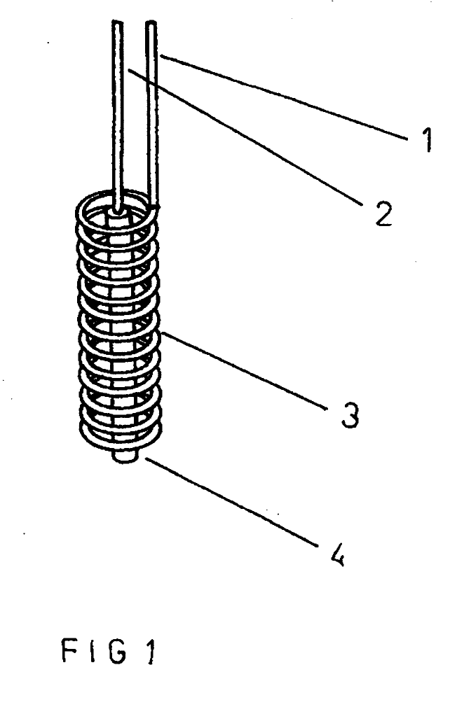

FIG. 1 is a perspective view of a FIG. 1 number 1 is an insulated conductive wire that provides direct current power to the anode 16 cathode 14 14 FIG. 1 number 2 is the insulated conductive wire that provides current power to the anode 16 FIG. 1 number 3 is the anode 16 coil FIG. 1 number 4 is the cathode 14 core.

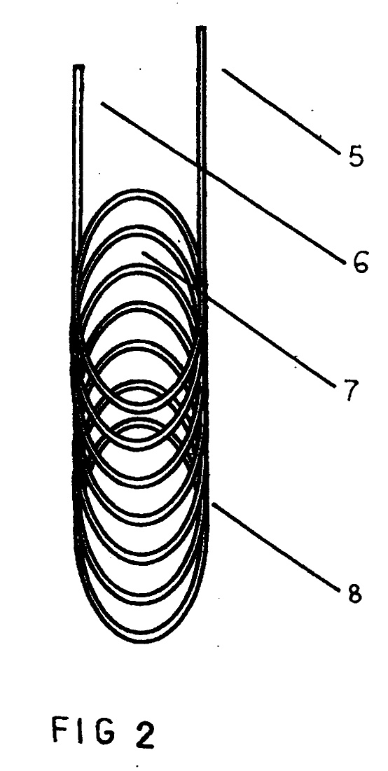

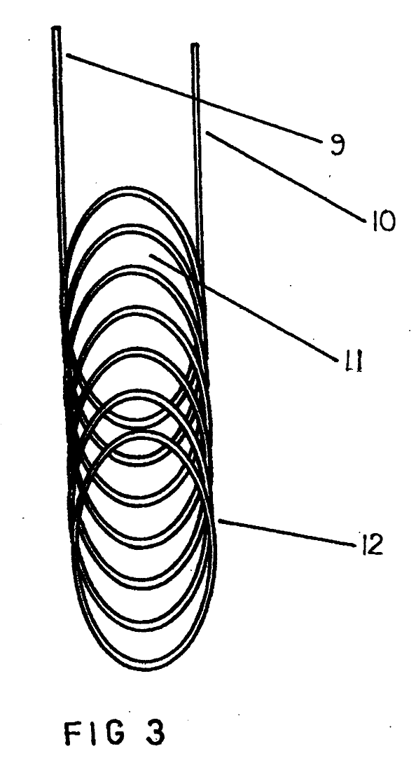

FIG. 2 is a perspective view of an inner inductive coil FIG. 2 number 5 is the insulated electrical conductive wire providing connectivity from the outer inductive coil to the 1st oscillator tank circuit FIG. 2 number 6 is the insulated electrical conductive wire providing connectivity from the outer inductive coil to the 1st oscillator tank circuit FIG. 2 number 7 is the regular spacing of the electrical induction coil that make up the inductance portion of the oscillator tank circuit FIG. 2 number 8 is the 45 degree angle relative to the wiring of FIG. 2 number 5 and FIG. 2 number 6 FIG. 2 number 8 is also 90 degree relative to the outer inductor coil FIG. 3 number 12.

FIG. 3 is a perspective view of an outer inductor coil FIG. 3 number 9 is an insulated conductive wire to provide connectivity from the outer inductive coil to the 2nd oscillator 20 tank circuit FIG. 3 number 10 is an insulated electrical conductive wire to provide connectivity from the outer inductive coil to the 2nd oscillator 20 tanks circuit FIG. 3 number 11 is the regular spacing of the outer inductor coil to create regular inductance for the 2nd oscillator 20 tank circuit FIG. 3 number 12 is the 45 degree angle that the inductive outer coil is relative to the angle of the FIG. 3 number 9 insulated electrical conductive wire and FIG. 3 number 10 insulated electrical conductive wire FIG. 3 number 12 is also 90 degree relative to the inner inductor coil FIG. 2 number 8.

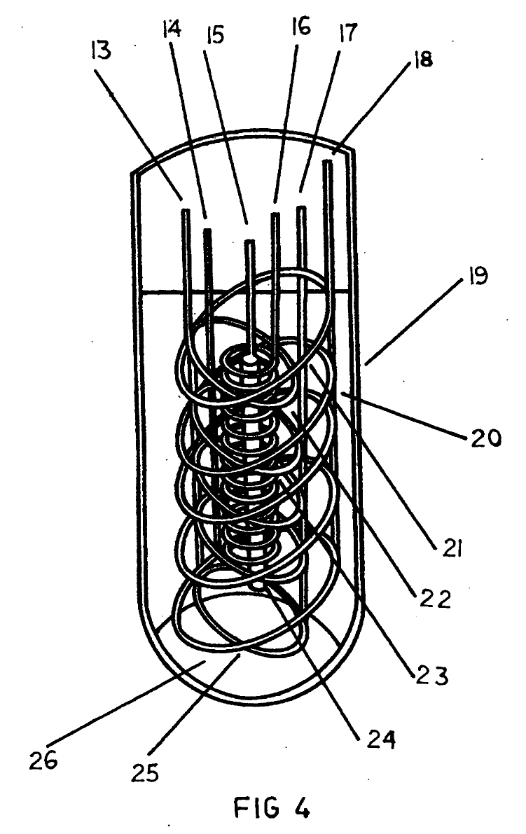

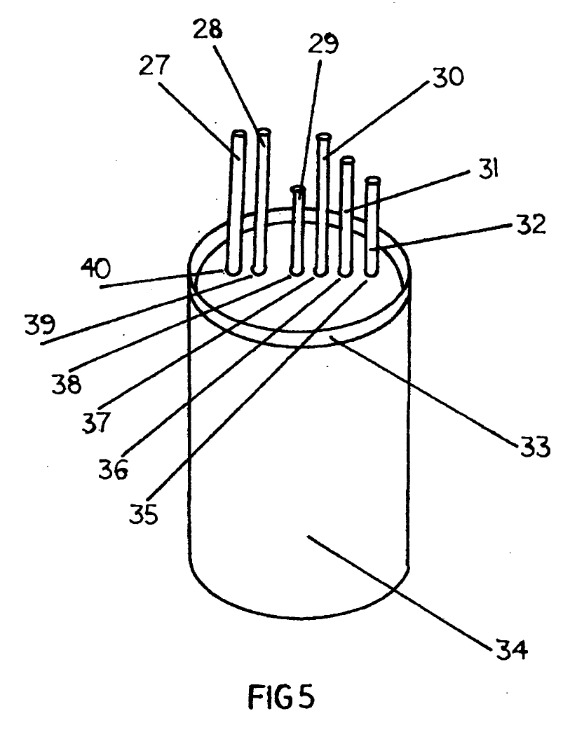

FIG. 4 is a perspective view of a vessel 24 that contains the inner and outer inductive coils with anode 16 and cathode 14 components with electrolyte 22 heavy water and electrical insulated and non insulated components FIG. 4 number 13 is an insulated conductive wire that connects to the 1st oscillator tanks circuit FIG. 4 number 14 is an insulated conductive wire that connects to the 2nd oscillator 20 tank circuit FIG. 4 number 15 is an insulated conductive wire that connects the cathode 14 to a power source FIG. 4 number 16 is an insulated conductive wire that connects the anode 16 to a power source FIG. 4 number 17 is an insulated conductive wire that connects the outer inductive coil to the 1st oscillator tank circuit FIG. 4 number 18 is the insulated conductive wire that connects the outer inductive coil to the 2nd oscillator 20 tank circuit FIG. 4 number 19 is a vessel 24 that will support the electrolyte 22 solution and the lid for the vessel 24 FIG. 4 number 20 is the electrolyte 22 heavy water solution FIG. 4 number 21 is the angle of incidence of the outer inductive coil that is 45 degrees angle relative to the FIG. 4 number 18 insulated conductive wire FIG. 4 number 22 is the angle of incidence of the inner inductive coil that is 45 degrees relative to the FIG. 4 number 13 insulated conductive wire and is 90 degrees relative to the outer inductive coil FIG. 4 number 23 is the anode 16 FIG. 4 number 24 is the cathode 14 FIG. 4 number 25 shows the 90 degree angle of incidence of the inner and outer inductive coils FIG. 4 number 26 is the bottom of the vessel 24 that support the lid to the vessel 24 and the electrolyte 22 and heavy water solution FIG. 4 number 92 is an representation of the electrolyte 22 level that cover the inner and outer inductive coil the cathode 14 and anode 16 FIG. 5 is a perspective view of a vessel 24 lid holes wires FIG. 5 number 34 is the vessel 24 that will prove support for the electrolyte 22 and heavy water solution and lid FIG. 5 number 33 is the lid that will isolate the atmosphere from the electrolyte 22 solution FIG. 5 number 32 is the insulated electrical conductive wire that connects the FIG. 4 number 18 insulated electrical conductive wire to the 2nd oscillator 20 tank circuit FIG. 5 number 31 is the insulated electrical conductive wire to the 1st oscillator tank circuit FIG. 5 number 30 is the insulated electrical conductive that provides power to the FIG. 4 number 16 insulated electrical conductive wire FIG. 5 number 29 is the insulated electrical conductive wire that provides power to the FIG. 4 number 15 insulated electrical conductive wire FIG. 5 number 28 is the insulated electrical conductive wire that connects the FIG. 4 number 14 insulated electrical conductive wire FIG. 5 number 27 is the insulated electrical conductive wire that connects the FIG. 4 number 13 wire to the 1st oscillator tank circuit FIG. 5 number 35 is a hole in the FIG. 5 number 33 lid this hole is snug enough to prove support to the inductive outer coil inside the vessel 24 and snug enough to seal any outside atmosphere from creating contamination to the electrolyte 22 heavy water solution in the vessel 24 FIG. 5 number 36 is a hole in the FIG. 5 number 33 lid this hole is snug enough to provide support to the inductive inner coil inside the vessel 24 24 and snug enough to seal any outside atmosphere from creating contamination to the electrolyte 22 heavy water solution in the vessel 24 FIG. 5 number 37 is a hole in the FIG. 5 number 33 lid this hole is snug enough to provide support to the cathode 14 inside the vessel 24 and snug enough to seal any outside atmosphere from creating contamination to the electrolyte 22 heavy water solution in the vessel 24 FIG. 5 number 38 is a hole in the FIG. 5 number 33 lid this hole is snug enough to seal any outside atmosphere from creating contamination to the electrolyte 22 heavy water solution in the vessel 24 FIG. 5 number 39 is a hole in the FIG. 5 number 33 lid this hole provides support to the inner inductive coil inside the vessel 24 this hole is also snug enough to seal outside atmosphere from creating contamination to the electrolyte 22 heavy water solution FIG. 5 number 40 is a hole in the FIG. 5 number 33 lid this hole is snug enough to provide support to the outer inductive coil inside the vessel 24 this hole is also snug enough to seal outside atmosphere from creating contamination to the electrolyte 22 heavy water solution.

FIG. 6 is a perspective view of an additional embodiment of the configuration of the inductive inner and outer loops and the placement of the anode 16 relative to the cathode 14 FIG. 6 number 41 is the insulated electrical wire that connects the 1st oscillator tank circuit to the inner electrical inductive coil FIG. 6 number 42 is the insulated electrical wire that connects the 2ns oscillator tanks circuit to the outer electrical inductive coil FIG. 6 number 43 is a insulated electrical wire that connects the power source to the cathode 14 FIG. 6 number 44 is the insulated electrical conductive wire that is connected to the cathode 14 note this arrangement places the cathode 14 wire outside of both inner and outer inductive loop coils FIG. 6 number 45 is the electrolyte 22 heavy water solution FIG. 6 number 44 is the anode 16 FIG. 6 number 47 is the outer coil degree angle of incidence relative to the FIG. 6 number 46 wire FIG. 6 number 48 is the inner coil with 45 degree angle of incidence to the FIG. 6 number 41 insulated electrical wire and 90 degree relative angle of incidence to the FIG. 6 number 41 insulated electrical wire and 90 degrees relative angle of incidence to the outer electromagnetic inductive coil FIG. 6 number 50 is the cathode 14 FIG. 6 number 51 is the 90 degree angle of incidence that is relative to the inner inductive coil loop FIG. 6 number 52 is the bottom of the vessel 24 that supports the electrolyte 22 heavy water solution and lid FIG. 6 number 93 is the electrolyte 22 heavy water solution line depicting the electrolyte 22 heavy water covering the inner and outer inductive coil and the anode 16 and cathode 14 components. it is believed that the optimium range of electromagnetic frequency range is the megahertz range of frequencies for both oscillators

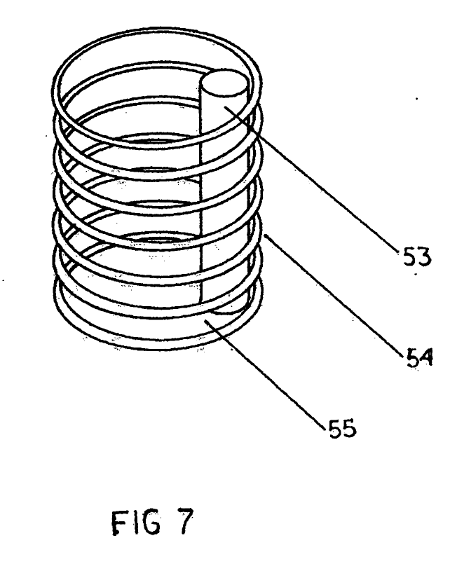

FIG. 7 is a perspective view of an alternative embodiment of the inner and outer coil configuration the FIG. 7 number 55 is the inductive coil FIG. 7 number 54 is the regular spacing of the inductive coil FIG. 7 number 53 is the addition of an magnetic core to increase the electromagnetic waves being generated FIG. 7 number 94 is the insulated electrical conductive wiring that connects the inductive coil to the oscillator tank circuit FIG. 7 number 95 is an insulated electrical conductive wiring that connects the inductive coil to the oscillator tank circuit.

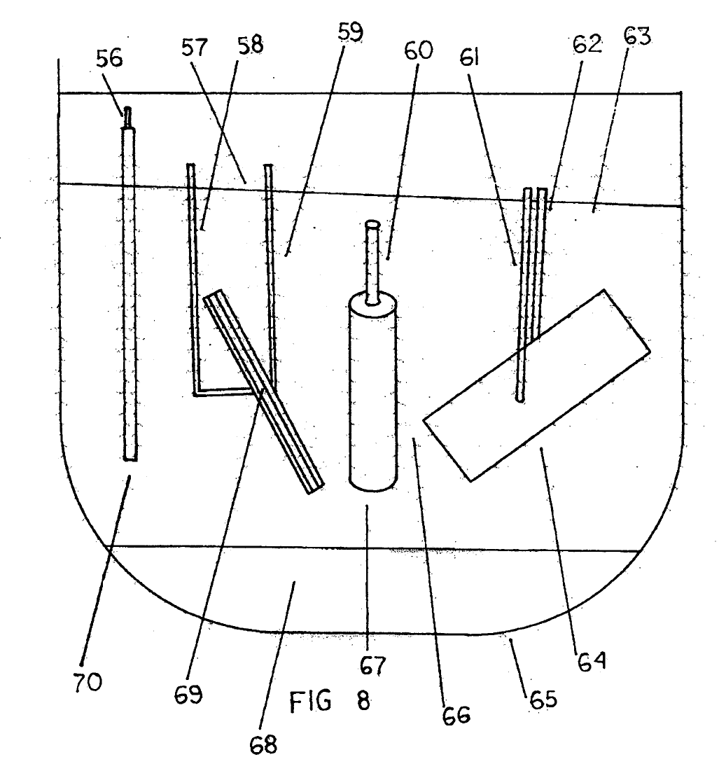

FIG. 8 is a perspective view of an alternative embodiment of vessel 24 that supports the heavy water electrolyte 22 with oscillator cathode 14 anode 16 FIG. 8 number 64 is the solid state oscillator 32 which is also 45 degree angle of incident to the FIG. 8 number 69 and FIG. 8 number 61 is the wire that support to the solid state oscillator 32 and provides connectivity to the oscillator tank circuit FIG. 8 number 59 is an wire that provides support to the solid state oscillator 32 and provides connectivity to the oscillator tank circuit FIG. 8 number 60 is an insulated conductive wire that provide support to the cathode 14 FIG. 8 number 59 is an insulated conductive wire that provide support to the cathode 14 FIG. 8 number 59 is an insulated conductive wire that provide support to the second oscillator FIG. 8 number 58 is an insulated conductive wire that provides support to the second oscillator circuit FIG. 8 number 69 is the 2nd solid state oscillator 32 and is referenced 90 degrees to the 1st oscillator and also at an angle of incidence of 45 degrees to the FIG. 8 number 59 wire and FIG. 8 number 58 wire and is also 90 degree angle of reference to the 1sat oscillator FIG. 8 number 63 is the heavy water electrolyte 22 solution FIG. 8 number 68 is the bottom of the vessel 24 FIG. 8 number 56 is the cathode 14 FIG. 8 number 70 is the anode 16 FIG. 8 number 56 is an insulated electrical conductive wire to connect the anode 16 to the power source.

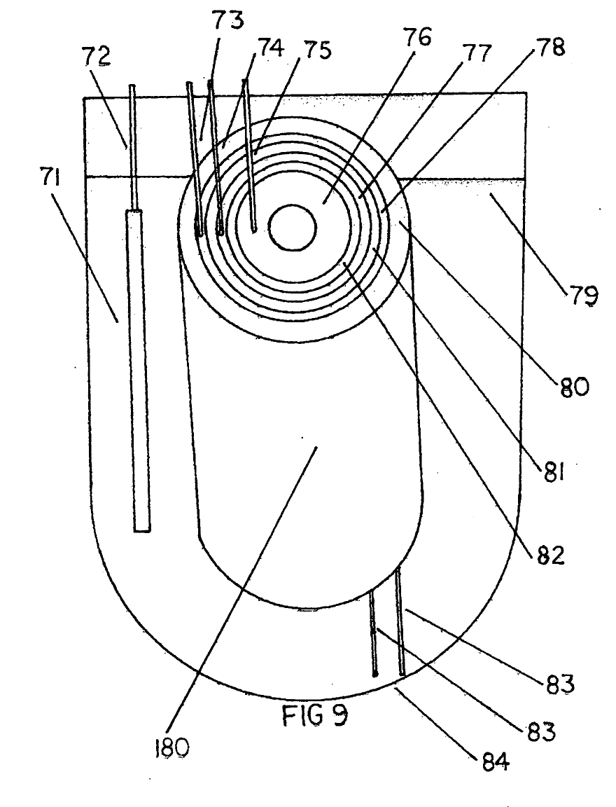

FIG. 9 is a perspective view of an alternative embodiment an anode 16 inner oscillator outer oscillator electrolyte 22 anode 16 16 FIG. 9 number 71 is the anode 16 FIG. 9 number 72 is an insulated electrical wire that connects the FIG. 9 number 71 cathode 14 to a power source FIG. 9 number 73 is the outer oscillator FIG. 9 number 74 is the inner oscillator FIG. 9 number 75 is the cathode 14 core FIG. 9 number 77 is an electrical insulator FIG. 9 number 78 is an electrical insulator FIG. 9 number 80 is an electrical insulator FIG. 9 number 79 is an representation of the electrolyte 22 heavy water solution FIG. 9 number 81 is the outer oscillator core FIG. 9 number 82 is the inner oscillator core FIG. 9 number 97 is an insulated electrical wire providing power and connects to the 1st oscillator electromagnetic tank circuit FIG. 9 number 83 is an insulated electrical wire providing power and connects to the 2nd oscillating electromagnetic tank circuit FIG. 9 number 84 is the bottom of the vessel 24 that provides support for the FIG. 5 number 33 lid and contains the electrolyte 22 solution FIG. 9 number 180 is the cathode 14 core. it is believed that the optimium range of electromagnetic frequency range is the megahertz range of frequencies for both oscillators

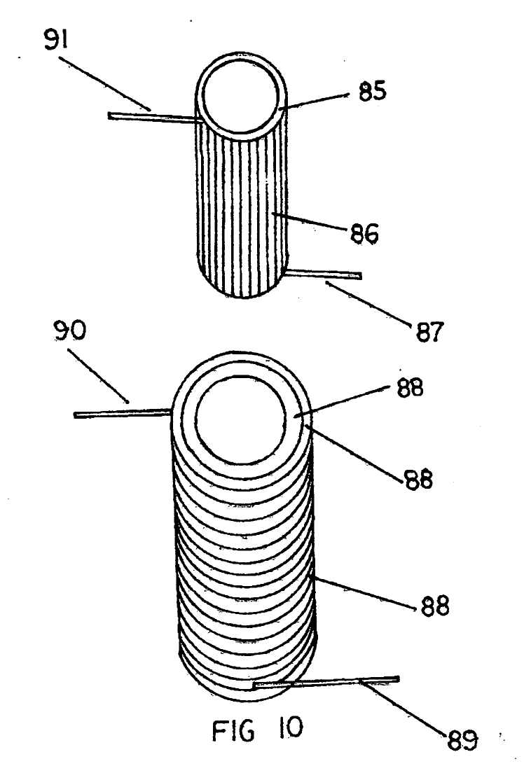

FIG. 10 is a perspective view of an alternative embodiment of inner oscillator core outer oscillator core FIG. 10 number 85 is the solid state oscillating inner core FIG. 10 number 86 shows the orientation of the oscillating electromagnetic wave produced by the solid state oscillator 32 FIG. 10 number 87 is the insulated electrical conducting wire that connects the inner solid state core to an electrical oscillating tank circuit FIG. 10 number 91 is the insulated electrical conducting wire that connects the inner solid state core to an electrical oscillation tank circuit FIG. 10 number 88 is the electrical insulator that separates the inner oscillating core to the outer oscillating core FIG. 10 number 99 is the solid state oscillating outer core FIG. 10 number 100 is the orientation of the oscillating electromagnetic wave produced by the solid state oscillator 32 FIG. 10 number 89 is an insulated electrical conducting wire that connects the outer solid state core to an electrical oscillation tank circuit. it is believed that the optimium range of electromagnetic frequency range in this alternative enbodiment is the terahertz range of frequencies for both oscillators

FIG. 11 is a perspective view of an overall construction of the cold fusion apparatus FIG. 11 number 101 is the electrical conductive wires that connect the power plug FIG. 11 number102 to a power source FIG. 11 number 103 is the positive alternative current voltage insulated electrically conductive wire FIG. 11 number 104 is the neutral alternative current voltage insulated electrical conductive wire FIG. 11 number 105 is the power supply 10 assemble FIG. 11 number 106 is the power distribution module supplying power to the FIG. 11 number 107 1st oscillator FIG. 11 number 108 is the 2nd oscillator 20 FIG. 11 number 109 is the insulated electrical conductive wire connecting the 1st oscillator adjustable tank circuit to the outer inductor coil FIG. 11 number 110 is the insulated electrical conductive wire connected the 2nd oscillator 20 adjustable tank circuit to the inner inductor coil FIG. 11 number 111 is the insulated electrical conductive wire connecting the cathode 14 to the power supply 10 10 assemble FIG. 11 number 105 FIG. 11 number 112 is the insulated electrical conductive wire connecting the anode 16 to the power supply 10 assemble FIG. 11 number 105 FIG. 11 number 113 is the insulated electrical conductive wire connecting the FIG. 11 number 2nd oscillator 20 adjustable tank circuit to the inner inductor coil FIG. 11 number 114 is an insulated electrical conductive wire connecting the 1st oscillator adjustable tank circuit to the outer inductor coil FIG. 11 number 115 is an hole in the FIG. 121 lid that is large enough to fit an wire though the hole and sung enough to provide isolation of the outside atmosphere air to the heavy water electrolyte 22 solution FIG. 11 number 116 is an hole in the FIG. 121 lid that is large enough to fit an wire though the hole and sung enough to prove isolation of the outside atmosphere to the heavy water electrolyte 22 solution FIG. 11 number 117 is an hole in the FIG. 121 lid that is large enough to fit an wire though the hole and sung enough to provide isolation of the outside atmosphere to the heavy water electrolyte 22 solution FIG. 11 number 118 is an hole in the FIG. 121 lid that is large enough to fit an wire though the hole and sung enough to provide isolation of the outside atmosphere to the heavy water electrolyte 22 solution FIG. 11 number 119 is an hold in the FIG. 121 lid that is large enough to fit an wire though the hole and sung enough to provide isolation of the outside atmosphere to the heavy water electrolyte 22 solution FIG. 11 number 121 is an hold in the FIG. 121 lid that is large enough to fit an wire though the hole and sung enough to provide isolation of the outside atmosphere to the heavy water electrolyte 22 solution FIG. 11 number 123 is the vessel 24 that supports the lid and electrical wiring to support he components inside the vessel 24 FIG. 11 number 124 is the adjustment that is part of the 2nd oscillator 20 capacitors of the colpitts oscillator tank circuit FIG. 11 number 125 is the 1st adjustable oscillator tank circuit FIG. 11 number 153 is the-switch that connects the power supply 10 common ground to the 2nd oscillator 20 tank circuit. it is believed that the optimium range of electromagnetic frequency range is the megahertz range of frequencies for both oscillators

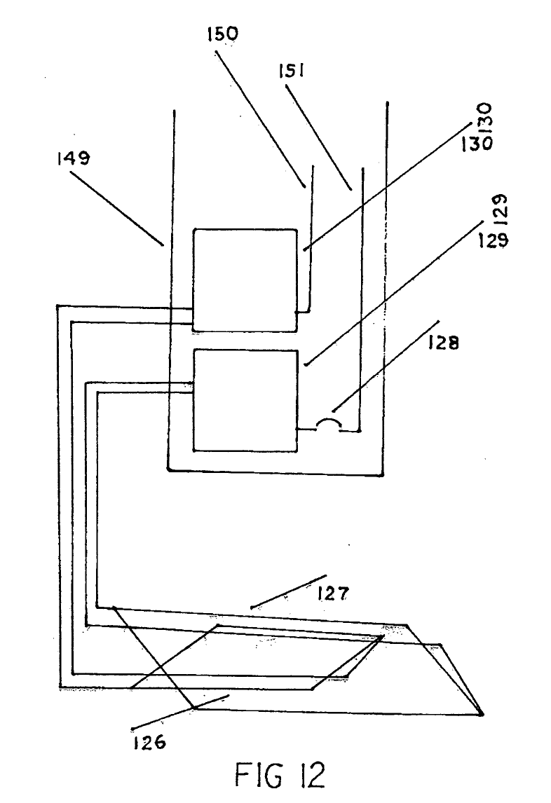

FIG. 12 is a perspective view of the connection of the oscillator tank circuits to the inner and outer inductive coils FIG. 12 number 126 is an representation of the inner inductive coil FIG. 12 number 127 is an representation of the outer inductor coil FIG. 12 number 128 is the switch that gives common ground to the 2nd adjustable oscillator tank circuit FIG. 21 number 129 is the 2nd adjustable oscillator tanks circuit FIG. 12 number 130 is the 1st adjustable oscillator tank circuit FIG. 12 number 149 is the representation of the power supply 10 assembly FIG. 12 number 150 is the common ground that connects to the FIG. 12 number 129 adjustable oscillator tank circuit FIG. 12 number 151 is the common ground that connects to the FIG. 12 number 130 adjustable oscillator tank circuit.

FIG. 13 is a perspective view of an of the complete setup to adjust the 1st and 2nd oscillator 20 tank circuit FIG. 13 number 131 is the insulated electrical plug that connects the supplied power to the power supply 10 assembly FIG. 13 number 133 FIG. 13 number 132 is the insulated electrical cord that supplies connectivity from the insulated electrical plug to the power supply 10 assembly FIG. 13 number 133 FIG. 13 number 134 is the insulated electrical wire that connects the FIG. 13 number 133 power supply 10 assembly to the anode 16 in FIG. 13 number 136 vessel 24 FIG. 13 number 135 is the tap component on the FIG. 13 number 177 electrical wire that connects the FIG. 13 number 133 power assembly 12 to the cathode 14 in FIG. 13 number 136 vessel 24 FIG. 132 number 137 is the oscillator scope that voltage measurement are taken off the tap circuit FIG. 13 number 135 tap.

FIG. 14 is a perspective view of a 1st oscillator colpitts circuit FIG. 14 number 138 is the common ground electrical connection that is supplied from the power supply 10 FIG. 14 number 139 is the electrical connection that is supplied from the power supply 10 ac circuit that provides energy to heat the filament in the FIG. 14 number 147 tube FIG. 14 number 140 is the electrical connection that is supplied from the power supply 10 ac circuit that provide energy to heat the filament in the FIG. 14 number 147 tube FIG. 141 is the electrical connection that supplies a grid voltage from the power supply 10 to the FIG. 14 number 147 tube FIG. 142 is the electrical connection that supplies a collector voltage to the tank circuit comprising the FIG. 14 number 143 inductor and the FIG. 14 number 144 cl adjustable capacitor FIG. 14 number 143 is the inductor coil that is in the vessel 24 contains the inductor coil FIG. 14 number 144 is an ganged adjustable tank circuit FIG. 14 number 145 is the device that connects the FIG. 14 number 144 capacitor tank circuit and FIG. 14 number 148 adjustable capacitor FIG. 14 number 147 is the triode tube FIG. 14 number 147. it is believed that the optimium range of electromagnetic frequency range is the megahertz range of frequencies for both oscillators

FIG. 15 is a perspective view of a power supply 10 assembly FIG. 15 number 154 is the insulated electrical plug that connects outside supplied power to the FIG. 15 number 157 power supply 10 assembly FIG. 15 number 155 is the electrical connection that connects the FIG. 15 number 154 electrical plus to the FIG. 15 number 156 power supply 10 collector voltage to the 1st adjustable oscillator and 2nd adjustable oscillator FIG. 15 number 159 is the grid biasing voltage for the 2nd oscillator 20 tube FIG. 15 number 161 is the electrical connection connecting the ac heater voltage to the 1st oscillator tube FIG. 15 number 162 is the electrical connection connecting the ac heater voltage to the 1st oscillator tube FIG. 15 number 178 is the electrical connection connecting the ac heater voltage to the 2nd oscillator 20 tube FIG. 15 number 163 is the electrical connection connecting the common ground from the power supply 10 FIG. 15 number 156 to the 1st oscillator tank circuit FIG. 15 number 165 is the electrical connection connecting the common ground from the power supply 10 from the power supply 10 FIG. 15 number 156 to the 2nd oscillator 20 tank circuit FIG. 15 number 164 is the switch that connects the electrical connection of the common ground to the 2nd oscillator 20 tank circuit. it is believed that the optimium range of electromagnetic frequency range is the megahertz range of frequencies for both oscillators

FIG. 16 is a perspective view of a 2nd oscillator 20 colpitts circuit FIG. 16 number 166 is the common ground electrical connection that is supplied from the power supply 10 FIG. 16 number 167 is the electrical connection that is supplied form the power supply 10 ac circuit that provides energy to heat the filament in the FIG. 16 number 176 tube FIG. 16 number 168 is the electrical connection that is supplied from the power supply 10 ac circuit that provide energy to heat the filament in the FIG. 16 number 176 tube FIG. 16 number 169 is the electrical connection that supplies a grid voltage from the power supply 10 to the FIG. 16 number 176 tube FIG. 16 number 170 is the electrical connection that supplies a collector voltage to the tank circuit comprising the FIG. 16 number 171 inductor and the FIG. 16 number 172 cl adjustable capacitor FIG. 16 number 171 is the inductor coil that is in the vessel 24 that containing the inductor coil FIG. 16 number 172 is an ganged adjustable tank circuit FIG. 16 number 173 is the device that connects the FIG. 16 number 174 adjustable capacitor and FIG. 16 number 172 adjustable capacitor FIG. 16 number 176 is the triode tube FIG. 16 number 175 is the resistor that supplies voltage bias to the emitter grid of the FIG. 15 number 176 tube it is believed that the optimium range of electromagnetic frequency range is the megahertz range of frequencies for both oscillators

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A cold fusion apparatus for creation of heat energy via the process of cold fusion comprising:
means for supply power to the cold fusion apparatus;
means for compression of deturium atom in a crystalline interistal structure element;
means for electrolyte reactions with heavy water and chemical reactions to create a electrolytic heavy water circuit;
means for creation of an electromagnetic field that is to transmit energy to the cathode;
means for creation of electromagnetic scalar wave with the 1st oscillator;
means for chemical reaction solution with heavy water, fluidly merged to said means for creation of electromagnetic scalar wave with the 1st oscillator, fluidly merged to said means for creation of an electromagnetic field that is to transmit energy to the cathode, fluidly merged to said means for electrolyte reactions with heavy water and chemical reactions to create a electrolytic heavy water circuit, and fluidly merged to said means for compression of deturium atom in a crystalline interistal structure element; and
means for containment of electrolyte solution anode cathode outer inductive coil inner inductive coil, supportively encompassing to said means for chemical reaction solution with heavy water.

2. The cold fusion apparatus in accordance with claim 1, wherein said means for supply power to the cold fusion apparatus comprises a power supply.

3. The cold fusion apparatus in accordance with claim 1, wherein said means for compression of deturium atom in a crystalline interistal structure element comprises a cathode.

4. The cold fusion apparatus in accordance with claim 1, wherein said means for electrolyte reactions with heavy water and chemical reactions to create a electrolytic heavy water circuit comprises an anode.

5. The cold fusion apparatus in accordance with claim 1, wherein said means for creation of an electromagnetic field that is to transmit energy to the cathode comprises a 1sc oscillator.

6. The cold fusion apparatus in accordance with claim 1, wherein said means for creation of electromagnetic scalar wave with the 1st oscillator comprises a 2nd oscillator.

7. The cold fusion apparatus in accordance with claim 1, wherein said means for chemical reaction solution with heavy water comprises an electrolyte.

8. The cold fusion apparatus in accordance with claim 1, wherein said means for containment of electrolyte solution anode cathode outer inductive coil inner inductive coil comprises a vessel.

9. A cold fusion apparatus for creation of heat energy via the process of cold fusion comprising:
a power supply, for supply power to the cold fusion apparatus;
a cathode, for compression of deturium atom in a crystalline interistal structure element;
an anode, for electrolyte reactions with heavy water and chemical reactions to create a electrolytic heavy water circuit;
a 1sc oscillator, for creation of an electromagnetic field that is to transmit energy to the cathode;
a 2nd oscillator, for creation of electromagnetic scalar wave with the 1st oscillator;
an electrolyte, for chemical reaction solution with heavy water, fluidly merged to said 2nd oscillator, fluidly merged to said 1sc oscillator, fluidly merged to said anode, and fluidly merged to said cathode; and
a vessel, for containment of electrolyte solution anode cathode outer inductive coil inner inductive coil, supportively encompassing to said electrolyte.

10. The cold fusion apparatus as recited in claim 9, further comprising:
an o scope, for monitor of voltage and adjustment of 2nd oscillator to create electromagnetic scalar waves.

11. A cold fusion apparatus for creation of heat energy via the process of cold fusion comprising:
a power supply, for supply power to the cold fusion apparatus;
a cathode, for compression of deturium atom in a crystalline interistal structure element;
an anode, for electrolyte reactions with heavy water and chemical reactions to create a electrolytic heavy water circuit;
a 1sc oscillator, for creation or an electromagnetic field that is to transmit energy to the cathode;
a 2nd oscillator, for creation of electromagnetic scalar wave with the 1st oscillator;
an electrolyte, for chemical reaction solution with heavy water, fluidly merged to said 2nd oscillator, fluidly merged to said 1sc oscillator, fluidly merged to said anode, and fluidly merged to said cathode;
a vessel, for containment or electrolyte solution anode cathode outer inductive coil inner inductive coil, supportively encompassing to said electrolyte; and
an o scope, for monitor or voltage and adjustment of 2nd oscillator to create electromagnetic scalar waves.
